(19) United States
(12) Patent Application Publication
(10) Pub. No.: US 2011/0112855 A1
(43) Pub. Date: May 12, 2011

(54) SYSTEM AND METHOD FOR ASSISTING IN MAKING A TREATMENT PLAN

(75) Inventors: Xi Chen, Shanghai (CN); Xin Zhang, Shanghai (CN); Declan Patrick Kelly, Shanghai (CN); Anouk Charlotte O'Prinsen, Shanghai (CN)

(73) Assignee: KONINKLIJKE PHILIPS ELECTRONICS N.V., EINDHOVEN (NL)

(21) Appl. No.: 12/991,717

(22) PCT Filed: May 8, 2009
(86) PCT No.: PCT/IB2009/051902

§ 371 Date: Jan. 6, 2011

(30) Foreign Application Priority Data
May 12, 2008 (CN) 200810099135.2

(51) Int. Cl. G06Q 50/00; G06Q 90/00; G06Q 10/00

(52) U.S. Cl. 705/2; 705/500

(57) ABSTRACT

The present invention provides a method and device for assisting in making a patient treatment plan. The method comprises: a step of acquiring first data reflecting the self-training condition of a patient in the recent past stage, and a medical record of the patient; a step of analyzing said first data based on said medical record and a first professional knowledge; and a step of generating a training guide based on the result of said step of analyzing and a second professional knowledge, said training guide serving to guide said patient in performing the next stage of training.

### FIELD OF THE INVENTION

The present invention relates to a system and method for computer-assisted diagnosis and treatment, in particular to a system and method for computer-assisted rehabilitation treatment.

### BACKGROUND OF THE INVENTION

Patients with functional disorders of movement, language, cognition, and visual and auditory abilities caused by diseases or accidents need to undergo a rehabilitation treatment. After leaving hospital, the patients will usually perform self-rehabilitation training at home according to their doctor's advice so as to improve their physical condition continuously, and then go to the rehabilitation center or hospital for reexamination regularly. In order to achieve an ideal rehabilitation effect, the patients need to perform correct training following the doctor's directions, and wrong methods cannot help the patients recover and may possibly make problems worse.

Therefore, it is very important for doctors or therapists to understand the rehabilitation conditions of the patients at home and make a follow-up rehabilitation plan accordingly.

However, many elderly persons suffer from memory loss or a language functional disorder resulting from serious diseases, e.g. a stroke, and hence are unable to describe their home self-rehabilitation training conditions in detail.

In addition, some inexperienced rehabilitation therapists need a set of systems providing them with professional knowledge for gradually gathering experience as well. The work efficiency of these experienced doctors or therapists will be greatly reduced if they receive a patient and spend much time to understand his/her past medical history and family rehabilitation training condition each time.

### SUMMARY OF THE INVENTION

This invention provides a computer-assisted diagnosis and treatment system and method for making a follow-up training plan based on pre-stored professional knowledge of the system obtained through analyzing family training data, the patients' chief complaints, and the doctors' observation and test results.

A method of assisting in making a patient treatment plan according to the invention comprises steps of:
acquiring first data reflecting the self-training conditions of a patient in the recent past stage, and a medical record of the patient;
analyzing said first data based on said medical record and a first professional knowledge;
generating a training guide based on the result of said step of analyzing and a second professional knowledge, said training guide serving to guide said patient in performing the next stage of training.

Another object of the invention is to design a system for assisting in making a patent treatment plan, comprising:
a first module for acquiring first data reflecting the self-training conditions of a patient in the recent past stage, and a medical record of the patient;
a second module for analyzing said first data based on said medical record and a first professional knowledge;
a third module for generating a training guide based on the result of said step of analyzing and a second professional knowledge, said training guide serving to guide said patient in performing the next stage of training.

The method and system of the invention will enable doctors or therapists to understand the home self-training conditions of a patient conveniently and efficiently and to obtain a system-recommended next-stage training guide to suit these conditions, thereby improving the work efficiency and working quality greatly.

The present system is adapted for rehabilitation treatment of stroke patients and patients with functional disorders of movement, language, and cognition owing to whatever cause, and also adapted to help a coach make a plan for the training conditions in the training process of athletes.

### DETAILED DESCRIPTION OF THE FIGURES

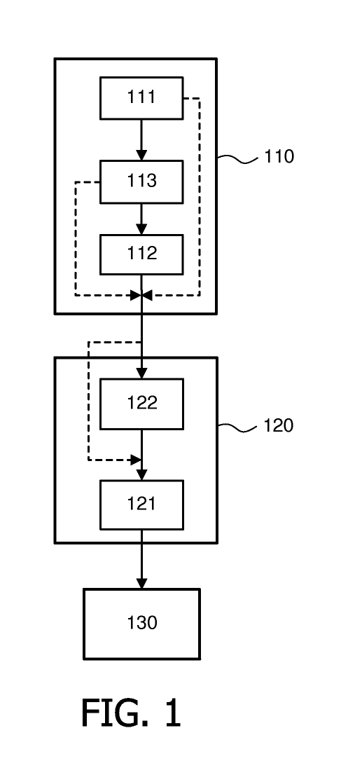

FIG. 1 is a flowchart of the method of assisting in making a treatment plan according to the invention;

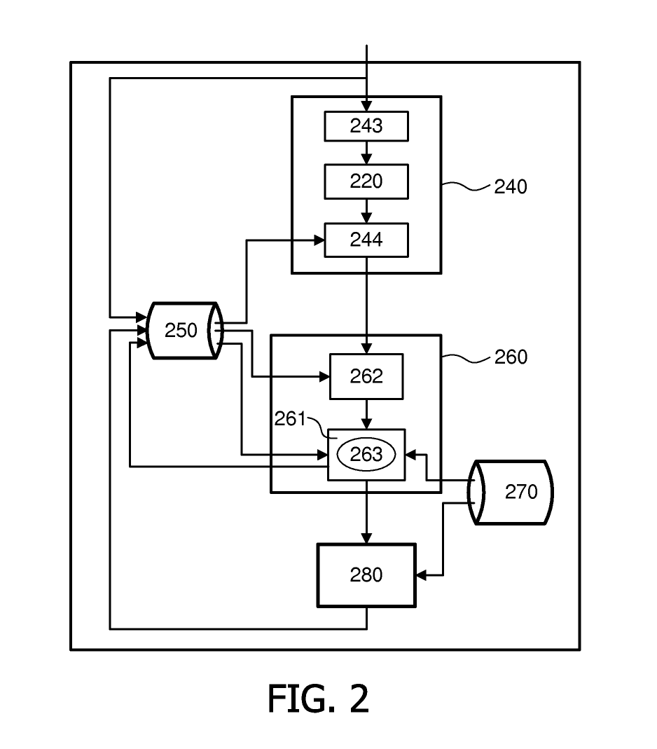

FIG. 2 is a functional block diagram of the system for assisting in making a treatment plan according to the invention;

The principle of the invention will be explained in detail with reference to the following embodiments and drawings.

### SPECIFIC EMBODIMENTS

FIG. 1 is a flowchart of the method of assisting in making a treatment plan according to the invention. The method comprises a step 110 of acquiring first data reflecting the self-training conditions of a patient in the recent past stage, and acquiring a medical record of the patient.

The method further comprises a step 120 of analyzing said first data based on said medical record and a first professional knowledge.

The method additionally comprises a step 130 of generating a training guide based on the result of said step 120 of analyzing and a second professional knowledge, said training guide serving to guide said patient in performing the next stage of his/her training.

The first data reflecting the self-training conditions of a patient in the recent past stage may include: recent-stage training data (original data) and statistical induced data based on the recent-stage training data following the training guide formulated by doctors. Said statistical data identify the problems existing in the patient's home training and the degree of progress. The original self-training data and the statistical analysis data reflect the patient's recent-stage self-training condition.

The training data may include but not limited to: the training programs carried out, the training times in each program, the duration of each item of training, the frequency of each item of training, the quantization value of the quality achieved, etc. For example: the degree of motor smoothness, the stability of the trunk and the flexibility of joints during motor training. Another example: language fluency, accuracy of pronunciation, and the speed of speaking, etc., during language training.

The statistical data may include but not limited to: the statistics of the quantity of the accomplished programs, the statistics of the quality of the accomplished programs, the list of abnormal phenomena with statistical significance. During the upper limb training of stroke patients, for example, a statistical analysis of different actions from several groups may first find an action that is inconsistent with the target action in each group and then classify this in accordance with the movement tracking mode so as to generate a plurality of movement sub-category sets. Meanwhile, a representative movement is generated within the movement tracking mode for each movement subcategory. All simple joint movements representative of all movement sub-categories are analyzed in this manner, such as the shoulder joint movement track, and the proportions of movement sub-category sets occupied by inconsistent situations are calculated. If such a proportion exceeds a certain threshold, the shoulder joint may be identified as an abnormal phenomenon.

The acquiring step 110 comprises a receiving step 111 for receiving the training data of a patient. Owing to the differences between home systems for recording, the data offered by some patients include not only the original self-training data but also the results of a statistical analysis of the original self-training data in accordance with the requirements of the training guide; such first data can be directly adopted by the analyzing step to analyze the causes that bring about the problems occurring during patient training and any abnormalities in the overall progress.

However, the data supplied by some patients are only original self-training data or are not statistically sufficiently analyzed. In that case the training data of a patient need to be analyzed on the basis of the recent-stage training guide so as to find out the problems and progress occurring during the patent's recent training.

If the received patient data are only original self-training data, said step 110 of acquiring first data further comprises a step 112 of analyzing the recent-stage self-training data according to the requirements of the training guide at a recent stage after the receiving step 111. The analyzing step 112 can then generate the statistical analysis data that completely represent the self-training condition of the patient.

The receiving step 111 receives data by any known method such as from a network (wired or wireless), a portable storage device (flash disk or portable hard disk), etc.

The analyzing step 112 classifies the original self-training data by means of statistical induction so as to reflect the self-training condition of the patient at a recent-stage in the form of a cartogram, problem list, etc.

The medical record comprises: the basic information on a patient, for example name, sex, age, stature, weight, etc.; the past medical history, for example whether the patient has had other diseases, what kind of treatment the patient has undergone, what the recovery condition was, etc., before suffering from the present illness; the history of the present illness, such as the process of the onset of the illness, what kind of treatment the patient receives, what the symptoms are, all chief complaints from patient, the result of the doctor's observation, and the results of various examinations and tests carried out by the doctor in response to the chief complaints and observations; as well as any other necessary information, such as whether the patient suffers complications, the family situation, and the patient's mental condition.

Alternatively, if the patient training data received by said receiving step are encrypted data, the acquiring step 110 may further comprise a decrypting step 113. The decrypting method may be any one from known encryption technologies.

In the analyzing step 120, the first professional knowledge relates to possible causes of certain problems or symptoms, any detection methods required, and the tools or procedures for performing said detection in the medical field. After the first data and medical record have been acquired in said acquiring step 110 on the basis of the first professional knowledge, the causes that bring about various situations, such as problems occurring during the patient's home training and any abnormalities in the patient's progress, may be obtained in the analyzing step 120.

Taking the problem of shoulder joint abnormality as an example, it may be derived from the first professional knowledge that possible causes triggering said shoulder joint abnormality may be found in the joint itself or elsewhere. The causes of the joint itself include pain-related causes, fractures, and so on; the non-joint causes include muscle weakness and muscular atrophy owing to nerve impairment. The pain-related possible causes include neurogenic pain caused by neural nerve impairment, hypertonus, shoulder joint subluxation, shoulder joint contracture, etc. Shoulder joint fractures comprise fracture of the proximal end of the humerus, fracture of the scapula, clavicular fracture, etc. The first professional knowledge may further relate to methods of testing or examining joint subluxation, such as palpation, X-ray imaging, etc. The causes of shoulder joint abnormal phenomena can be concluded step by step on the basis of this first professional knowledge.

The analyzing step 120 performs an analysis of said first data, said medical record, and said first professional knowledge by asking hierarchical questions, i.e. the analyzing step 120 further comprises a questioning step 121.

Preferably, the first professional knowledge can be directly stored in the system in the form of questions. These questions per se, the relations between questions and abnormal situations, the logical relation between abnormal situations, and the logical relation between different questions directly reflect said first professional knowledge.

Said asking of hierarchical questions as per levels means that the content of the next question is decided on in dependence on the answer to the preceding question, i.e. questions are asked step by step, level by level, which has the advantage that they are more pertinent, collect useful information more efficiently, and find the causes of problems as quickly as possible.

Since it needs to provide questions level by level in an interactive manner, step 121 further comprises a step of receiving an answer to a question and deciding on a further question in dependence on said answer.

The level-wise supply of a set of hierarchical questions renders it possible to obtain the causes of all abnormal items in the first data, so that a suitable treatment training guide for these causes can be determined.

Said series of questions comprises not only the questions to which the answers can be directly obtained through asking or observing the patients, but also the questions to which answers are obtained by the doctor's test, including the description of the testing method and device, which description of the testing method relates, for example, to palpation, active and passive tests, etc. The questions to which answers need to be obtained through tests only may be, for example, a set of clinical testing tools that enable the doctor to use and input data, or may be valuation levels as well.

For example, the question may be “whether the patient suffers pain”. A further example, the question needs to be answered “whether there is a sensory disorder?” (test description: taking the diagnosis of proprioception in the deep sensation examination as an example, the patient closing eyes during examination, the examiner moving the patient's fingers and toes lightly and asking the patient to mention the direction of movement.)

Taking the above analysis of shoulder joint abnormal questions as an example, step 121 of providing a set of hierarchical questions may ask the following questions, first according to the first professional knowledge:

Does the patient suffer pain?

Does the patient have a shoulder joint fracture?

Depending on the answers to the above two questions, it is decided whether a question at the next level will be asked and what that question should be. If there is no shoulder joint fracture, for example, all questions relating to this item will end and no further question is asked. If there is a pain, the question at the next level is:

Is there joint subluxation? (with joint subluxation test guide enclosed)

Is there hypertonus? (with hypertonus test guide enclosed)

Alternatively, said analyzing step 120 may further comprise a step 122 of comparing the first data with second data and third data, said second data reflecting at least one of said patient's self-training conditions in the previous stage which is earlier than the recent past stage, said third data reflecting the self-training condition of at least one other patient; while said step of providing questions further comprises questions in dependence on the comparison result.

Once the patient has undergone the training in a plurality of stages in the analysis of the first data, some problems in the patient's training process may be found by comparing the training condition of this patient at least one previous stage and the training condition of other patients with similar situation and problem.

The function of the comparing step is to combine the patient's training condition with more information and data in order to obtain a more comprehensive valuation and a better judgment of the patient's problems.

For example, the progress of the patient at a recent stage is slower than his/her progress in the previous several stages; however, other similar patients have the same problem, which indicates that this is a normal phenomenon. The patient will have a slow progress at this stage. If other, similar patients still make good progress at this similar stage, it indicates that there is a problem with the patient's training at this stage. The analyzing step further analyzes the reasons why there is little progress by asking questions. For example, the questions may be:

Has the patient's enthusiasm for training decreased?

Why has the patient's enthusiasm decreased? And so on.

The step 121 of providing questions further comprises a set of questions at different levels for collecting said patient information, including a medical record.

When a patient visits for the first time, the doctor needs to create a medical record file for the patient, which file serves as a reference for the doctor when the patient pays a return visit.

The first questions for collecting the information of the patient may appear in a standard form, i.e. the questions are to the same for all patients. Next, a further question is decided on in dependence on individual patients' answers to respective specific questions in the standard forms, and then a complete medical record of every patient is finally obtained.

There may be a plurality of basic standard forms. For example, one of said forms is a questionnaire for collecting the past medical history of a patient. The detailed questions may include:

What treatment was received previously?

What intervention was carried out on the present disease, for example, an operation, medication?

What symptoms (movement function, sensitivity, sound, pain, cognitive disorder, communication, vision, etc.) are there?

What health problems have been experienced?

The answers to these questions will be verified in the subsequent questions that need to be answered such that it is ascertained whether the chief complaint of the patient is consistent with the test result.

Another example of the basic form may be the patient's feedback on his/her own home training situation. Based on the patient's home training, the content of the questionnaire may add new questions to find the causes that bring about the problems arising in the home training program of the patient. The patient's feedback to his/her own home training situation can be combined with the input home training data to determine jointly the problems occurring in home training and analyze causes.

Based on the patient's home self-training situation, the step of providing questions will generate suggestions on tests aimed at fully and accurately evaluating the capabilities and difficulties of the patient, obtaining the test result by means of questions. The test methods may comprise palpation techniques, active and passive tests, etc.

This medical record information will be used in the following condition analysis, the formulation of the training guide, and the adjustment of the training plan in dependence on the recent-stage training condition when a return visit is paid, because this information must always be taken as the foundation and basis for making a training guide.

Further to the analysis result of step 120 and the second professional knowledge, the present invention further comprises a step 130 of generating a training guide, said training guide serving to guide the patient in performing the next-stage training. Said second professional knowledge of the invention is a solution to a given problem, which solution will differ subject to different causes of the problems and different basic conditions of the patient.

Depending on various functional conditions of the patient and the will of the patient per se, said training guide comprises any one or more of the following: movement guide, language training guide, communication skills training guide, auditory training guide, visual training guide, psychological training guide, habits and customs guide, and any guiding materials that are deemed necessary by the doctor. A training guide for stroke patients will at least comprise a movement guide, because most of these patients suffer from a movement functional disorder.

The movement guide may guide the patient to perform self-training at home in the form of video or pictures, possibly in combination with explanatory text. The language training guide may include a segment of audio content that the patient is asked to simulate, or the text content is to be read aloud by the patient. The time, frequency and accomplishing quality of these trainings can be monitored in various known manners. For example, movement tracking technology is used to measure the accomplishing quality and quantity of a movement. Speech recognition technology is used to monitor the language training.

Still taking shoulder joint abnormality as an example, if it is learned from the result of the analyzing step 120 that the shoulder joint is not fractured and there are no muscle weaknesses and muscular atrophy due to nerve impairment, the movement mode of said shoulder joint abnormality is caused by joint subluxation. According to the second professional knowledge, step 130 then generates a training guide to help the patient perform self-training at home. The training guide may be, for example, a series of actions specially designed for the movement functional disorders caused by joint subluxation, said actions comprising exercises for relieving the pain caused by subluxation through specific skills in using the uninjured hand to support the injured hand, and simultaneously using the uninjured hand to assist the injured hand to perform active shoulder joint stretching exercises for stimulating the muscle group that stabilizes the shoulder joint.

FIG. 2 is a functional block diagram of the system for assisting in making a patient treatment plan.

The first module 240 performs said step of acquiring first data reflecting the self-training condition of a patient in the recent past stage, and a medical record of the patient (for details, see the above explanation of said acquiring step 110).

The first module 240 comprises a user interface 243 for receiving user data (i.e. the patient's self-training data from the recent past). If the user data are the original self-training data plus the statistical analysis data, the received user data are the acquired first data only (see the description of step 110 in the above text for details).

The first module 240 further comprises a fourth unit 244; if the user interface 243 receives the original training data, the fourth unit 244 serves to perform step 112 of analyzing the self-training data in the recent past in accordance with the training guide for this recent past (see the description of step 112 in the above text for details).

The first database 250 is used to store all patient information including a medical record, the patient's home self-training data acquired in the acquiring step 110, and the training guide generated in the generating step 130, etc.

The second database 270 is a professional knowledge database for storing the professional knowledge in the relevant medical fields, including the first professional knowledge and the second professional knowledge.

The second module 260 is used to analyze the first data acquired by the first module 240 against the background of said medical record and the first professional knowledge (for details, see the above description of the analyzing step 120).

The second module 260 comprises a first unit 261 for performing said step 121 of providing questions. The first unit 261 further comprises an answer-receiving unit 263 for receiving answers so as to realize an interactive questioning in accordance with the levels of said step 121.

For example, the question at the first level is provided according to the first data acquired from the first module 240, the medical record acquired from the first database 250, and the related professional knowledge acquired from the second database 270, whereupon a further question is put in dependence on the answer received by the answer-receiving unit 263, so that the root causes of the problems that the patient had in the recent past are found out step by step in the end.

In a further example, the first unit 261 acquires a standard questionnaire from the second database 270, receives a questionnaire input for the doctor or therapist from said answer-receiving unit 263 (through inquiring, observing, and testing of patients), provides a further question again depending on the input, and so on until the end. In this way the step of providing a set of questions for collecting a medical record is performed, and the complete user information is created immediately after the input of an answer to the question. Such user information is archived by the first database 250 in charge of storing user information.

The second module 260 further comprises a second unit 262 for comparing said first data with second data and third data, said second data reflecting at least one of the self-training conditions of the patient in the previous stage, said third data reflecting the self-training condition of at least one other patient. Said first unit 261 also needs to provide the first set of questions according to the result of a comparison by the second unit 262 (see the above description of the comparing step 122 for details).

The third module 280 is used for generating a training guide in dependence on the result analyzed by the second module 260 and the second professional knowledge, and said training guide will be used to guide the patient in performing the next stage of training (see the above description of the generating step 130 for details).

Once generated, the training guide can be printed out to the patient in a file form, stored in a portable storage device like a hard disk, flash disk, etc., or transmitted to the patient via a wired or wireless Internet. A backup copy of the patient information may be saved in the first database 250, if so desired.

Said system of the invention may further include a fourth module 220 for performing the decrypting step 113.

Besides encrypting and decrypting the data content for reasons of system security, it may further integrate an electronic smart card as a software key for activating the software in the portable storage device, e.g. a flash disk. This electronic smart card ensures that the system can recognize a valid storage device and then exchange information therewith, otherwise the system is unable to operate normally.

It should be understood that said first database and second database are only functional modules used for explaining the system, and all data may be stored in the same database or be distributed over a plurality of databases. The database(s) may serve as part of the system, or may not form part of the system, for example said database(s) may be accommodated in other servers.

Said database consists of a storage device and the data stored therein.

The various modules and units described above may be comprised of a processor plus a storage device in which an instruction code is stored. The processors of said various modules may be integrated onto one or more processors, or said various storage devices may be integrated into a storage device as well. The function of said system may be realized by software, hardware, or a combination thereof.

1. A method of assisting in making a patient treatment plan, comprising:
a step (110) of acquiring a first data reflecting the self-training conditions of a patient in the recent past stage and a medical record of the patient;
a step (120) of analyzing said first data based on said medical record and a first professional knowledge;
a step (130) of generating a training guide based on the result of said step (120) of analyzing and a second professional knowledge, said training guide serving to guide said patient in performing the next stage of his/her training.

2. The method according to claim 1, said step (120) of analyzing comprising a step (121) of providing a set of hierarchical questions in dependence on said first data, said medical record, and said first processional knowledge.

3. The method according to claim 2, said step (120) of analyzing comprising a step (122) of comparing the first data, second data, and third data, said second data reflecting at least one of the self-training conditions of said patient in the previous stage which is earlier than said recent past stage, said third data reflecting the self-training condition of at least one other patient; said step (121) of providing questions further comprising the asking of questions in dependence on the comparison result.

4. The method according to claim 1, wherein step (121) of providing questions comprises the asking of a set of questions for collecting said medical record.

5. The method according to claim 1, the step (110) of acquiring first data further comprising:
a step (111) of receiving the self-training data of the patient at the recent past stage;
a step (112) of analyzing said self-training data against the background of a training guide for this recent past stage.

6. The method according to claim 1, the step (110) of acquiring further comprising a decrypting step (113) for decrypting said first data.

7. The method according to claim 1, the step (110) of acquiring comprising the acquiring of said first data from a network, portable storage device, or portable hard disk.

8. The method according to claim 5, the step (111) of receiving comprising the receiving of said self-training data from a network, portable storage device, or portable hard disk.

9. The method according to claim 1, said training guide comprising at least a movement guide.

10. A system for assisting in making a patient treatment plan, comprising:
a first module 240 for acquiring first data reflecting the self-training condition of a patient in the recent past stage and a medical record of the patient;
a second module (260) for analyzing said first data based on the medical record and the first professional knowledge;
a third module (280) for generating a training guide based on the result of said analyzing step and the second professional knowledge, said training guide serving to guide said patient in performing the next-stage training.

11. The system according to claim 10, said second module (260) comprising a first unit (261) for providing a set of questions in levels in dependence on said first data and said medical record, and said first processional knowledge.

12. The system according to claim 11, said second module (260) comprising a second unit (262) for comparing the first data, second data, and third data, said second data reflecting at least one of the self-training conditions of said patient in the previous stage which is earlier than said recent past stage, said third data reflecting the self-training condition of at least one other patient; whereupon said first unit (261) provides questions in dependence on said comparison result.

13. The system according to claim 11, said first module (240) further comprising:
a user interface (243) for receiving user input data;
a fourth unit (244) for analyzing said user input data against the background of the training guide for the recent past stage.

14. The system according to claim 13, further comprising a fourth module (220) for decrypting said user input data.

15. The system according to claim 10, said training guide comprising at least a movement guide.
